(19) United States
(12) Patent Application Publication
(10) Pub. No.: US 2008/0303792 A1
(43) Pub. Date: Dec. 11, 2008

(54) Mouse structure

(76) Inventor: Kuei-Lin Chung, Taipei City (TW)

Correspondence Address: Troxell Law Office Pllc, Suite 1404, 5205 Leesburg Pike, Falls Church, VA, 22041, US

(21) Appl. No.: 11/882,781

(22) Filed: Aug. 6, 2007

(30) Foreign Application Priority Data
Jun. 11, 2007 (TW) 096209571

(51) Int. Cl. G06F 3/033

(52) U.S. Cl. 345/163

(57) ABSTRACT

An improved mouse structure, in which one side of a main body is provided with a depression corresponding to position of the fingers, and a micro joystick is disposed in the depression. Upward, downward, leftward and rightward directional contact portions are located on the micro joystick, and a control circuit of the mouse is electrically connected to the micro joystick. Accordingly, when the mouse is connected to a computer, contact with the upward/downward or leftward/rightward directional contact portions causes the micro joystick to produce signals which the control circuit converts into keyboard directional key signals that are output to the computer. Hence, the mouse is provided with mouse and keyboard functionality, thereby eliminating the need for the user to use both hands to simultaneously operate the mouse and the keyboard, but single handedly operate the mouse and the micro joystick to simultaneously control the mouse and the keyboard.

### BACKGROUND OF THE INVENTION

(a) Field of the Invention

The present invention relates to an improved mouse structure, and more particularly to a mouse configured with a micro joystick able to transmit keyboard directional key signals to control directional displacement of 3D software on a computer screen.

(b) Description of the Prior Art

Currently, input devices, which, besides the keyboard, includes most importantly a mouse, are necessary for computer users to operate a computer system, in particular, the arrival of the use of 3D windows in operating systems and many software applications has provided the computer with more powerful functionality. The computer user frequently installs dozens of software (for example, 3D windows application software such as SECOND-LIFE, GOOGLE-EARTH, HIPIHI, and the like). Hence, when the user wants to open software or needs the use of a certain function, then he often needs to spend some time locating the software or function.

However, although computer mice in the current market are provided with multifunction setting keys located on the main body of the mouse, nevertheless, as soon as the windows system is updated with additional functions, or the user needs to operate the aforementioned 3D windows software applications, then the original mouse is found to lack functionality to operate the 3D software, as well as lacking the function setting keys, and thus does not comply with use requirements, which is a cause for dissatisfaction.

### SUMMARY OF THE INVENTION

Hence, in light of the shortcomings of the aforementioned prior art, the inventor of the present invention, having accumulated knowhow and manufacturing experience of various input devices, attentively researched various methods to resolve such drawbacks, which, following continuous research and improvements, culminated in the design of a completely new improved mouse structure of the present invention.

A primary objective of the present inventions is to provide an improved mouse structure able to transmit keyboard directional key signals to control directional displacement of 3D software on a computer screen.

According to the aforementioned objective, one side of a main body of the mouse of the present invention is provided with a depression corresponding to the fingers, and a micro joystick is disposed in the depression. The micro joystick is provided with upward, downward, leftward and rightward directional contact portions, and a control circuit of the mouse is electrically connected to the micro joystick. When the mouse is connected to a computer, contact with the upward/downward or leftward/rightward directional contact portions of the micro joystick causes the micro joystick to produce signals which the control circuit converts into keyboard directional key signals that are output to the computer. Accordingly, the mouse of the present invention is provided with both mouse and keyboard functionality, thereby eliminating the need for the user to use both hands to simultaneously operate the mouse and the keyboard, while enabling the user to single handedly operate both the mouse and the micro joystick, thereby achieving the objective of simultaneous control of both the mouse and the keyboard.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an external elevational view of a mouse of the present invention (right hand use).

FIG. 2 shows a circuit block diagram of the mouse of the present invention (wired circuit).

FIG. 3 shows a circuit block diagram of another embodiment of the mouse of the present invention (wireless circuit).

FIG. 4 shows an external elevational view of another embodiment of the mouse of the present invention (left hand use).

### DETAILED DESCRIPTION OF THE PREFERRED EMBODIMENTS

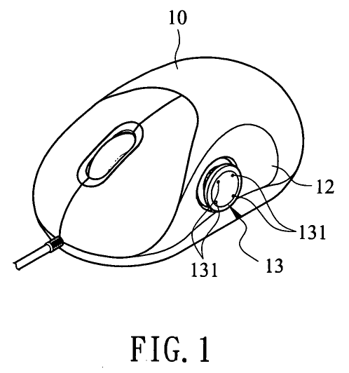

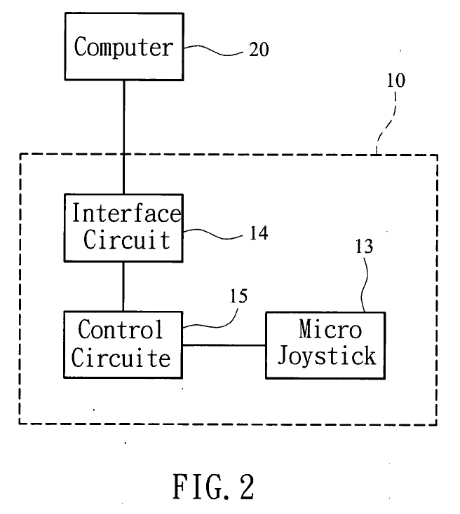

The present invention relates to an improved mouse structure, as depicted in FIGS. 1 and 2, which show a mouse of the present invention (for example, an optical mouse) comprising a main body 10, one side of which is provided with a depression 12 corresponding to position of the fingers of a user. A micro joystick 13 is disposed in the depression 12, and upward, downward, leftward and rightward directional contact portions 131 are located on the micro joystick 13, moreover, the fingers can be made to contact any of the directional contact portions 131 to produce different directional signals.

In addition, an interface circuit 14 (for example, a USB interface circuit) and a control circuit 15 are configured interior of the main body 10, wherein the control circuit 15 is electrically connected to the interface circuit 14, thereby enabling the control circuit 15 to be connected to a computer 20 through the interface circuit 14. Moreover, the control circuit 15 is further electrically connected to the micro joystick 13.

Based on the assembly of the aforementioned component members, when the mouse is connected to the computer 20, contact with the upward/downward (or leftward/rightward) contact portions 131 of the micro joystick 13 causes the micro joystick 13 to produce signals which the control circuit 15 converts into keyboard directional key signals that are output to the computer 20 to implement control of directional displacement of 3D software on the screen of the computer 20.

Accordingly, the mouse of the present invention is provided with both mouse and keyboard functionality, thereby eliminating the need for the user to use both hands to simultaneously operate the mouse and the keyboard, while enabling the user to single handedly operate both the mouse and the micro joystick 13 to simultaneously control both the mouse and the keyboard.

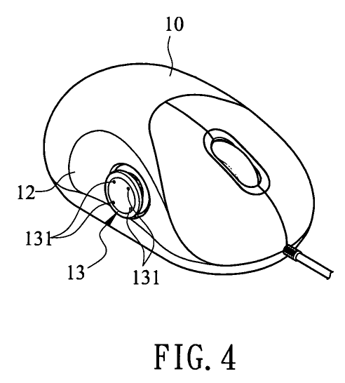

Referring to FIGS. 1 and 4, the depression 12 of the mouse of the present invention can be defined on the left side of the main body 10 with the micro joystick 13 disposed in the depression 12, thereby facilitating right hand use of the mouse (as depicted in FIG. 1); or the depression 12 can be defined on the right side of the main body 10 with the micro joystick 13 disposed in the depression 12 to facilitate left hand use of the mouse (as depicted in FIG. 4).

When the mouse of the present invention is connected to the computer 20, then 3D software can be configured for signals from the contact portions 131 of the micro joystick 13 to act as keyboard directional key signals, thereby enabling the keyboard directional key signals produced when fingers contact the upward/downward (or leftward/rightward) contact portions 131 of the micro joystick 13 to control directional displacement of the 3D software.

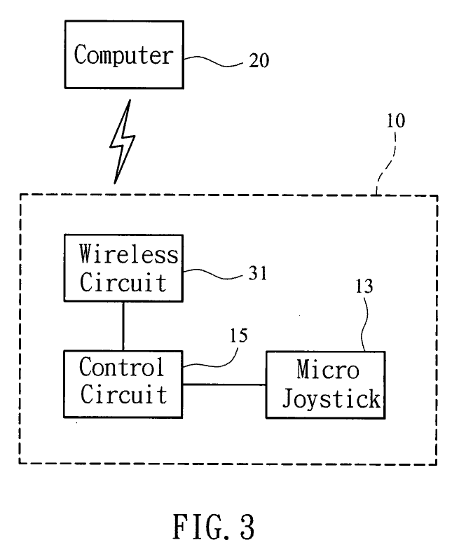

Referring to FIGS. 1 and 3, in another embodiment of the present invention, the depression 12 is defined on one side of the main body 10 at the position corresponding to the fingers of the user, and the micro joystick 13 is disposed in the depression 12. The upward, downward, leftward and rightward directional contact portions 131 are located on the micro joystick 13, and the fingers can be made to contact any of the directional contact portions 131 to produce different directional signals.

Furthermore, the main body in 10 is configured with a wireless circuit 31 (such as a RF wireless circuit) and the control circuit 15, wherein the control circuit 15 is electrically connected to the wireless circuit 31, thereby enabling the control circuit 15 to connect with the computer 20 by means of a wireless transmission mode using the wireless circuit 31. Moreover, the control circuit 15 is electrically connected to the micro joystick 13.

When the mouse is connected to the computer 20, contact with the upward/downward (or leftward/rightward) contact portions 131 of the micro joystick 13 causes the micro joystick 13 to produce signals which the control circuit 15 converts into keyboard directional key signals that are output to the computer 20 to implement control of directional displacement of 3D software on the screen of the computer 20.

Referring to FIGS. 1 and 4, in the embodiment of the present invention, the depression 12 is defined on the left side of the main body 10, and the micro joystick 13 is disposed in the depression 12, thereby facilitating right hand use of the mouse (as depicted in FIG. 1); or the depression 12 can be defined on the right side of the main body 10 with the micro joystick 13 disposed in the depression 12 to facilitate left hand use of the mouse (as depicted in FIG. 4).

Referring to FIG. 3, in the embodiment of the present invention, when the mouse of is connected to the computer 20, then 3D software can be configured for signals from the contact portions 131 of the micro joystick 13 to act as keyboard directional key signals, thereby enabling the keyboard directional key signals produced when fingers contact the upward/downward (or leftward/rightward) contact portions 131 of the micro joystick 13 to control directional displacement of the 3D software.

In conclusion, the improved mouse structure of the present invention is assuredly provided with an Innovative structure not found in prior art. Moreover, no similar product has been seen in any publication or in the market, the present invention is thus provided with undoubted originality. In addition, the present invention is provided with unique characteristics and functionality that are without comparison in prior art. Hence, the incomparable advancement of the present invention clearly complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A mouse structure, comprising:
a main body, one side of which is provided with a depression corresponding to position of the fingers;
a micro joystick disposed in the depression, upward, downward, leftward and rightward directional contact portions are located on the micro joystick;
an interface circuit configured interior of the main body; and
a control circuit configured interior of the main body and electrically connected to the interface circuit, thereby enabling the control circuit to be connected to a computer through the interface circuit, the control circuit is further electrically connected to the micro joystick;
when the mouse is connected to the computer, contact with the upward or downward, or leftward or rightward contact portions of the micro joystick causes the micro joystick to produce signals which the control circuit converts into keyboard directional key signals that are output to the computer to implement control of directional displacement of 3D (3 Dimensional) software on the screen of the computer.

2. The mouse structure according to claim 1, wherein the depression is disposed in the depression, thereby facilitating right hand use of the mouse.

3. The mouse structure according to claim 1, wherein the depression is defined on the right side of the main body, and the micro joystick is disposed in the depression, thereby facilitating left hand use of the mouse.

4. The mouse structure according to claim 1, wherein the interface circuit is a USB (Universal Serial Bus) interface circuit.

5. A mouse structure, comprising:
a main body, one side of which is provided with a depression corresponding to position of the fingers;
a micro joystick disposed in the depression, upward, downward, leftward and rightward directional contact portions are located on the micro joystick;
a wireless circuit configured interior of the main body; and
a control circuit configured interior of the main body and electrically connected to the wireless circuit, thereby enabling the control circuit to be connected to a computer through the wireless circuit, the control circuit is further electrically connected to the micro joystick; when the mouse is connected to the computer, contact with the upward or downward, or leftward or rightward contact portions of the micro joystick causes the micro joystick to produce signals which the control circuit converts into keyboard directional key signals that are output to the computer to implement control of directional displacement of 3D software on the screen of the computer.

6. The mouse structure according to claim 5, wherein the depression is defined on the left side of the main body, and the micro joystick is disposed in the depression, thereby facilitating right hand use of the mouse.

7. The mouse structure according to claim 5, wherein the depression is defined on the right side of the main body, and the micro joystick is disposed in the depression, thereby facilitating left hand use of the mouse.

8. The mouse structure according to claim 5, wherein the wireless circuit is a RF (Radio Frequency) wireless circuit.
